(19) United States
(12) Patent Application Publication
(10) Pub. No.: US 2015/0059184 A1
(43) Pub. Date: Mar. 5, 2015

(54) Methods of Fabricating a High Pressure Bushing and Supporting a Shaft

(71) Applicants: Scott Michael Barth, West Riverton, US (US); David Afton Nelson, West Riverton, UT (US)

(72) Inventors: Scott Michael Barth, West Riverton, US (US); David Afton Nelson, West Riverton, UT (US)

(73) Assignee: AKTIEBOLAGET SKF, Goteborg (SE)

(21) Appl. No.: 14/012,731

(22) Filed: Aug. 28, 2013

(51) Int. Cl. F16C 33/04; F16C 43/02

(52) U.S. Cl. CPC F16C 33/046; F16C 43/02
USPC 29/898.054; 29/898.07

(57) ABSTRACT

A method of fabricating a bushing for supporting a shaft within a housing includes: determining a size of a section of the housing inner circumferential surface and a size of a section of the shaft outer circumferential surface; fabricating a generally tubular body having an outer circumferential surface sized to fit within the housing inner surface section and an inner circumferential surface sized to receive at least a portion of the shaft; and separating the tubular body into a plurality of generally arcuate tube segments. Preferably, the tubular body is formed of a metallic material and is separated by cutting. A method of supporting a shaft within a housing includes forming an annular groove in the housing and fabricating a bushing in the manner described above to fit within the groove.

### BACKGROUND OF THE INVENTION

The present invention relates to bearings, and more particularly to bushings for high-pressure applications.

Plain bearings or bushings are well known and include a generally annular body with an inner circumferential surface for supporting a sliding and/or rotational movement of a cylindrical body, such as a shaft or piston, along a central axis. These bushings are typically installed within an annular groove or gland that retains the body with respect to the axis. In certain applications, the bushing can be installed within a gland by sliding the body axially into an open end of the gland, and then “closing” the gland with an adjacent structural member (e.g., retainer ring in a bearing block).

In other applications, the bushing must be installed within a “closed” gland that is spaced from the axial ends of a solid bore. In such cases, the bushing must be deflectable, at least to a certain extent, to enable the outside diameter of the body to inwardly deflect or contract for axial displacement of the body through the bore, and then expand outwardly when positioned within the gland. The bushings in such applications are typically formed of a polymeric material to enable such radial contraction and expansion. However, in high pressure applications, such polymeric bushings may lack the necessary material strength and thereby fail under loading.

### SUMMARY OF THE INVENTION

In one aspect, the present invention is a method of fabricating a bushing for supporting a shaft within a housing, the housing having an inner circumferential surface and the shaft having an outer circumferential surface. The method comprises the steps of: determining a size of a section of the housing inner circumferential surface and a size of a section of the shaft outer circumferential surface; fabricating a generally tubular body having an outer circumferential surface sized to fit within the housing inner surface section and an inner circumferential surface sized to receive at least a portion of the shaft; and separating the tubular body into a plurality of generally arcuate tube segments.

In another aspect, the present invention is a method of supporting a cylindrical body within a housing, the method comprising the steps of: forming an annular groove in an inner circumferential surface of the housing; providing a plurality of generally arcuate tube segments; and installing the tube segments within the annular groove such that the tube segments are aligned circumferentially about the central axis so as to form a generally tubular body configured to slidably support the cylindrical body.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is perspective view of a presently preferred construction of a multi-piece bushing, shown in an assembled state;

FIG. 2 is a perspective view of the multi-piece bushing of FIG. 1, shown in an exploded or “unassembled” view;

FIG. 3 is a perspective view of the multi-piece bushing shown installed in a housing;

FIG. 4 is an axial cross-sectional view of a presently preferred housing;

FIG. 5 is an enlarged, broken-way view of an axial cross-section of FIG. 3;

FIG. 6 is a perspective view of an alternative construction of a multi-piece bushing;

FIG. 7 is a side view of the multi-piece bushing of FIG. 1;

FIG. 8 is an enlarged view of section 8 of FIG. 7;

FIGS. 9A-9C, collectively FIG. 9, are each a broken-away, perspective view of an alternative interface of a first and second tube segment of the multi-piece bushing;

FIG. 10 is a side view of a solid bushing used to fabricate the multi-piece bushing, shown marked for cutting;

FIG. 11 is a side view of the bushing of FIG. 10 after the cutting process;

FIG. 12 is an axial cross-sectional view of a housing and a first tube segment of the bushing, viewed in a downward direction and depicting a first step in an installation process;

FIG. 13 is a perspective view of the housing with the first segment installed;

FIG. 14 is an axial cross-sectional view of the housing, the first tube segment and a second tube segment of the bushing, viewed in a downward direction and depicting a second step in the installation process;

FIG. 15 is a perspective view of the housing with the first and second segments installed;

FIG. 16 is an axial cross-sectional view of the housing, the first and second tube segments and a third tube segment of the bushing, viewed in a downward direction and depicting the beginning of a third step in the installation process;

FIG. 17 is an axial cross-sectional view of the housing and the first, second and third tube segments, depicting the completion of the installation process;

FIG. 18 is an axial cross-sectional view of the housing and bushing after installation; and

FIG. 19 is an axial cross-sectional view of the housing and installed bushing, showing the insertion of a movable cylindrical body supported by the bushing.

### DETAILED DESCRIPTION OF THE INVENTION

Certain terminology is used in the following description for convenience only and is not limiting. The words “upper” and “upward” designate directions in the drawings to which reference is made. The words “inner”, “inwardly” and “outer”, “outwardly” refer to directions toward and away from, respectively, a designated centerline or a geometric center of an element being described, the particular meaning being readily apparent from the context of the description. The terminology includes the words specifically mentioned above, derivatives thereof, and words of similar import.

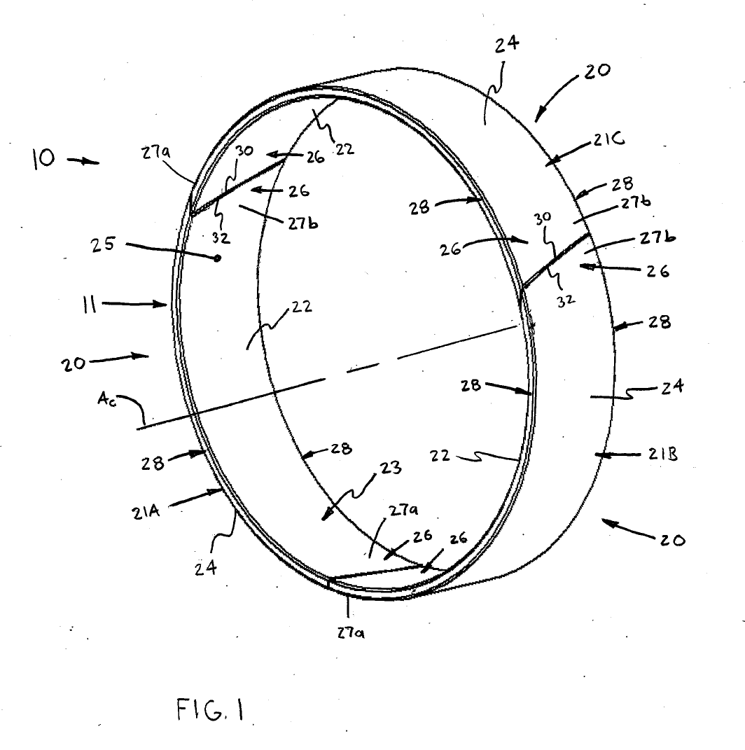

Referring now to the drawings in detail, wherein like numbers are used to indicate like elements throughout, there is shown in FIGS. 1-19 a multi-piece bushing 10 for supporting a movable cylindrical body 12 (FIG. 19) within a housing 14 having an axis A_{C}. The body 12 has an outer circumferential surface 12a with an outside diameter OD_{S} (FIG. 19) and is rotatable about, and/or linearly displaceable along, the axis A_{C}. The cylindrical body 12 may be any type of movable body requiring support, such as a rotary shaft, a linearly displaceable piston, etc. The housing 14 has an inner surface 16 extending circumferentially about the axis A_{C} and an annular groove 18 or “gland” formed in the surface 16 so as to extend radially outwardly from a remainder of the surface 16 and circumferentially about the axis A_{C}. The bushing 10 basically comprises a plurality of generally arcuate tube segments 20 disposeable within the groove 18 and alignable circumferentially about the housing axis A_{C} so as to form a generally tubular body 11 configured to slidably support the cylindrical body 12.

Preferably, each tube segment 20 is formed of a generally rigid metallic material, such as for example, low carbon steel, so that the bushing 10 is capable of supporting relatively higher loads or pressures than a similarly sized bushing formed of a polymeric material. By forming the bushing 10 of a plurality of tube segments 20, the metallic bushing 10 is capable of being installed within existing “closed” glands, particularly those in which a solid metallic bushing is incapable of deflecting to the extent necessary for installation. Although depicted as relatively thin-walled tube segments 20, each segment 20, and the resultant bushing 10 formed thereby, may have any appropriate thickness as required by the specific application of the bushing 10.

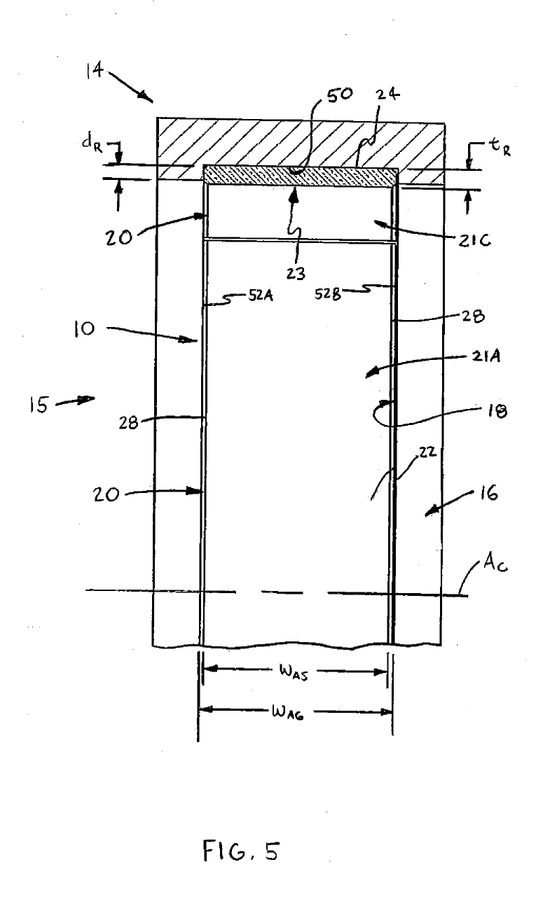

More specifically, each tube segment 20 has inner and outer circumferential surface sections 22, 24 respectively, two opposing radial ends 26 and two opposing axial ends or sides 28. Each one the tube segments 20 has an axial width W_{AS} between the two axial ends/sides 28 and a radial thickness t_{R} between the inner and outer surface sections 22, 24, as indicated in FIG. 5. The inner circumferential surface sections 22 of all of the plurality of tube segments 20 collectively form a generally continuous inner circumferential bearing surface 23 defining a bushing bore 25 when the segments 20 are disposed within the housing groove 18.

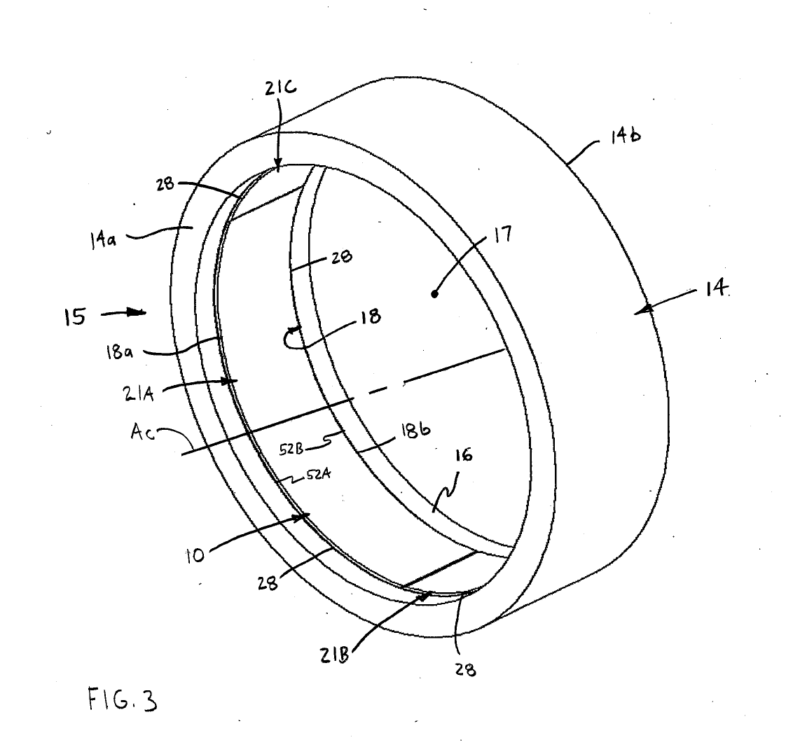

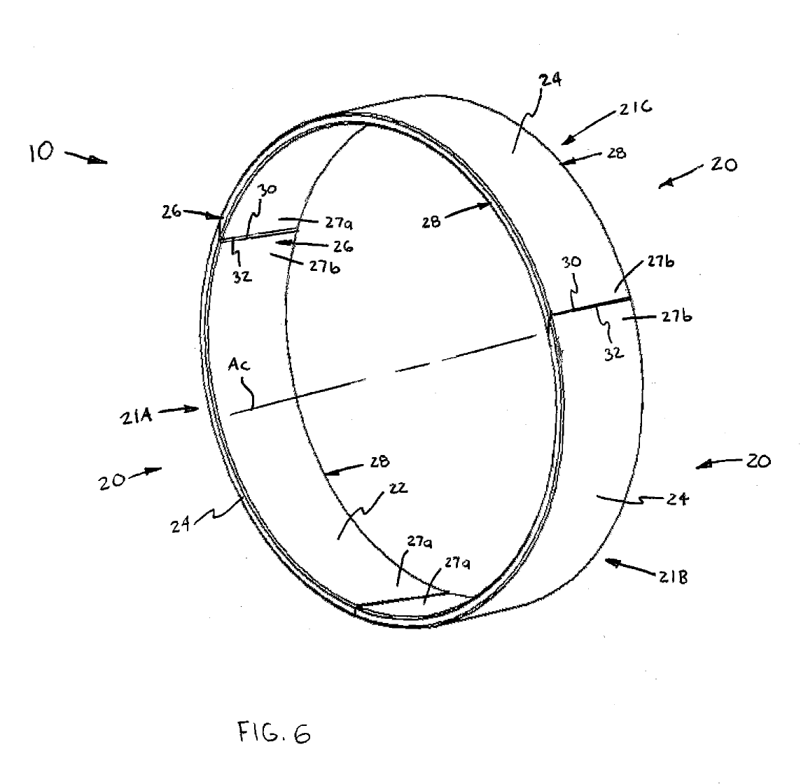

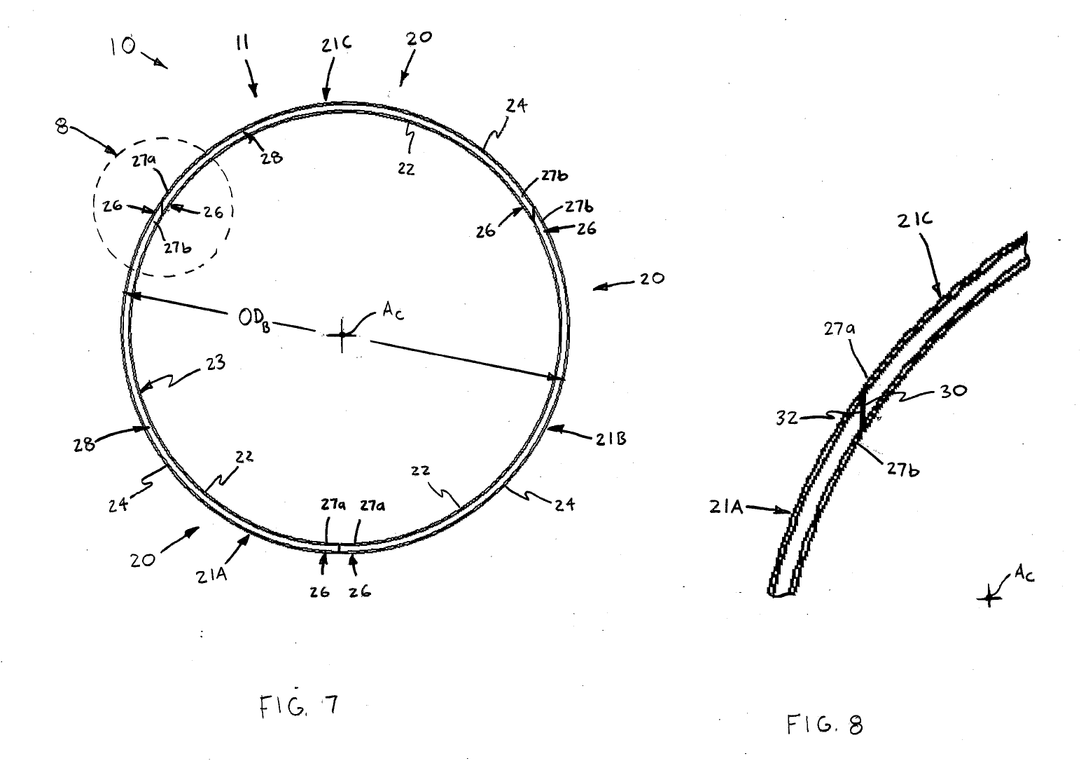

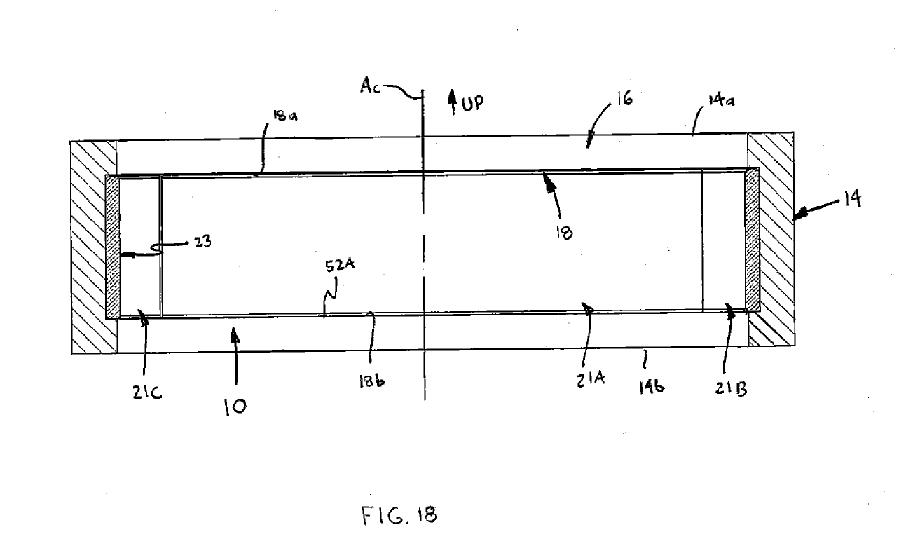

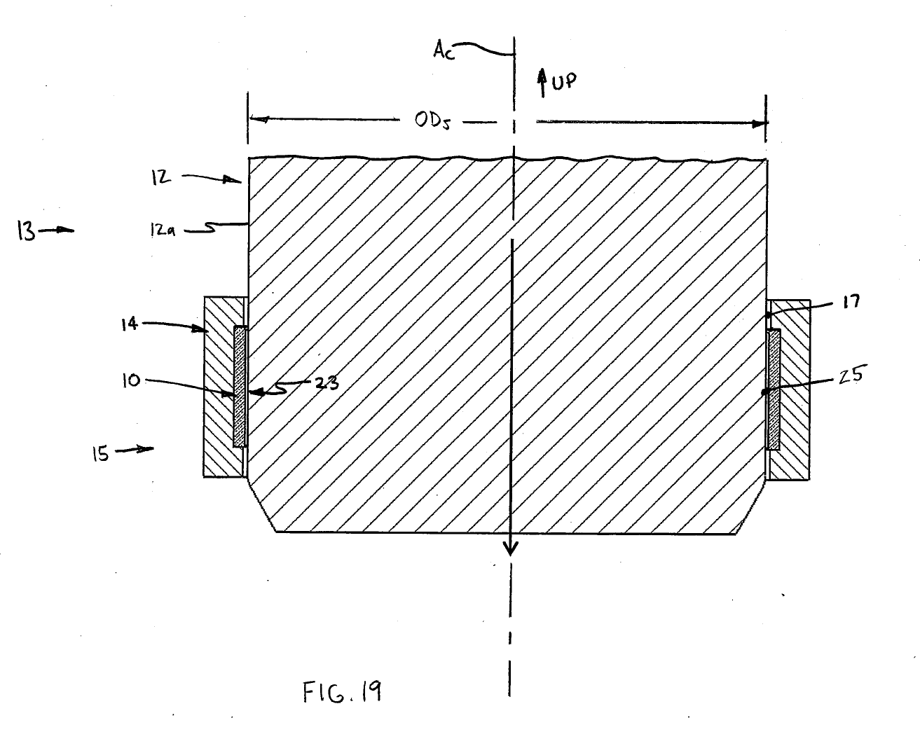

The bearing surface 23 is configured to slidably support the cylindrical body 12, so as to reduce friction when the body 12 linearly displaces or/and angularly displaces about the central axis A_{C}. Additionally or alternatively, the tube segments 20 may be sized to provide a bushing inside diameter ID_{B} (FIG. 7) with a magnitude relative to the magnitude of the cylindrical body outside diameter OD_{C} (FIG. 19) such that bearing surface 23 seals against the body outer circumferential surface 12a. Further, when the bushing 10 is installed in the groove 18, each segment radial end 26 is located generally adjacent to one of the radial ends 26 of one of the other tube segments 20 and each segment axial end 28 is generally axially aligned with one of the two axial ends 28 of each one of the other tube segments 20, as best shown in FIGS. 3 and 18.

That is, the tube segments 20 are spaced about the central axis A_{C} with the radial end 26 of each segment 20 generally abutting the end 26 of an adjacent segment 20 and the axial ends 28 on each side of all the segments 20 are generally aligned with each other to form one of two generally continuous axial side ends or edges. Although the radial ends 26 of the segments 20 are each located relatively closely proximal to the end 26 of the adjacent segment 20, there is preferably a radial clearance between at least some of the segment radial ends 26 to facilitate installation within the groove 18. In one preferred application, the total radial clearance between all the pairs of adjacent radial ends 26 of the tube segments 20 is about fifty-one thousands of an inch (0.051″), which results from three wire EDM cuts to a solid bushing in a preferred fabrication method, as discussed below. However, the actual radial clearance between any particular pair of segment radial ends 26 may be substantially lesser, such as when the radial ends 26 of two segments 20 are contacting each other.

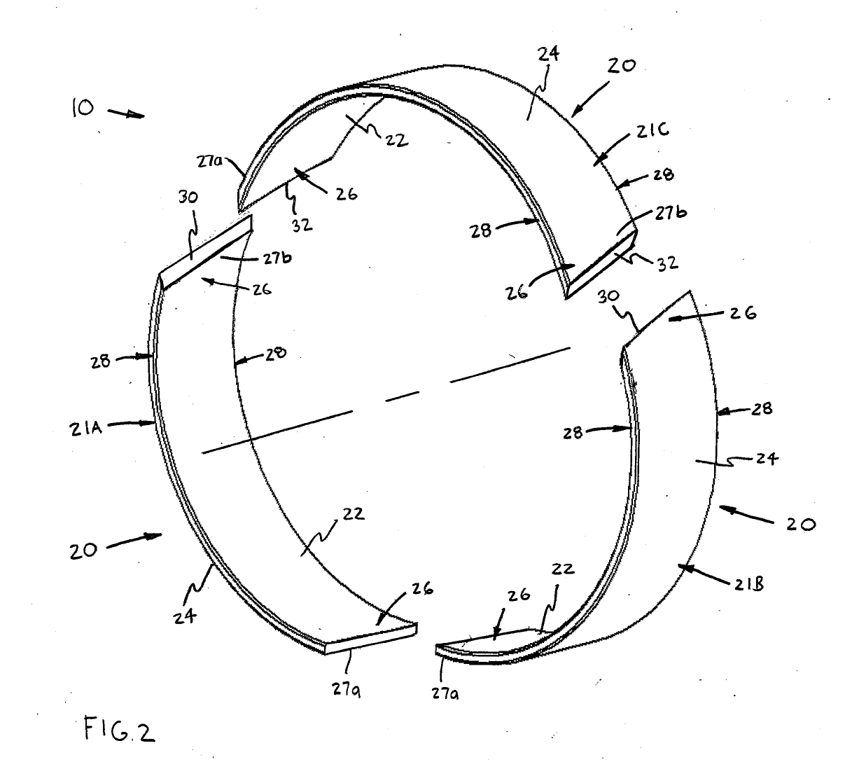

Preferably, the bushing 10 is formed of three pieces, such that the plurality of tube segments 20 includes a first segment 21A, a second segment 21B and a third segment 21C. However, the bushing 10 may include only two tube segments 20 or four or more segments 20 (no alternatives shown). As best shown in FIG. 2, each one of the first and second segments 21A, 21B preferably has a first radial end 27a adjacent to a first end 27a of the other one of the first and second segments 21A, 21B and an opposing, second radial end 27b with an angled end surface 30 facing generally “inwardly” or toward the central axis A_{C}. The third tubular segment 21C preferably has an angled end surface 32 on each one of first and second radial ends 27a, 27b, with each of the two angled end surfaces 32 of the third segment 21C facing generally “outwardly” or away from the central axis A_{C}.

As described in greater detail below, the first and second tube segments 21A, 21B are first installed within the housing groove 18 and then the third tubular segment 21C is installed in the groove 18 by positioning the segment 21C between the other two segments 21A, 21B and then displacing the third segment 21C generally radially outwardly. The two outwardly angled end surfaces 32 of the third segment 21C slide against the two inwardly-angled end surfaces 30 of the first and second segments 21A, 21B until each of the third segment end surfaces 32 are generally juxtaposed with a separate one of the angled end surfaces 30 of the first and second tube segments 21A, 21B.

Preferably, the inwardly-facing angled radial end surface 30 of each one of the first and second tube segments 21A, 21B extends generally obliquely between the two axial ends 28 of the segment 21A, 21B, as best shown in FIGS. 1 and 2. That is, the two angled end surfaces 30 are both angled so as to face generally radially inwardly toward the axis A_{C} and lay in a plane extending between the axial ends 28 that is skewed with respect to the central axis A_{C}, as opposed to being within a generally radial plane that includes or is parallel to the central axis A_{C}, as depicted in FIG. 6. Further, each one of the two outwardly-facing angled radial end surfaces 32 of the third tube segment 21C preferably extends generally obliquely between the two axial ends 28 of the third segment 21C. One of the two angled end surfaces 32 of the third tube segment 21C is oriented so as to generally mate with the angled radial end surface 30 of the first tube segment 21A and the other one of the two angled end surfaces 32 of the third tube segment 21C is oriented so as to generally mate with the angled radial end surface 30 of the second tube segment 21B. The obliquely-extending interfaces between the radial end surfaces 30, 32 of the three segments 21A, 21B and 21C reduces the potential for uneven wear on a linearly displacing cylindrical body 12 (e.g., a piston) as could be caused by a substantially axially-extending interface between the tube segments 20.

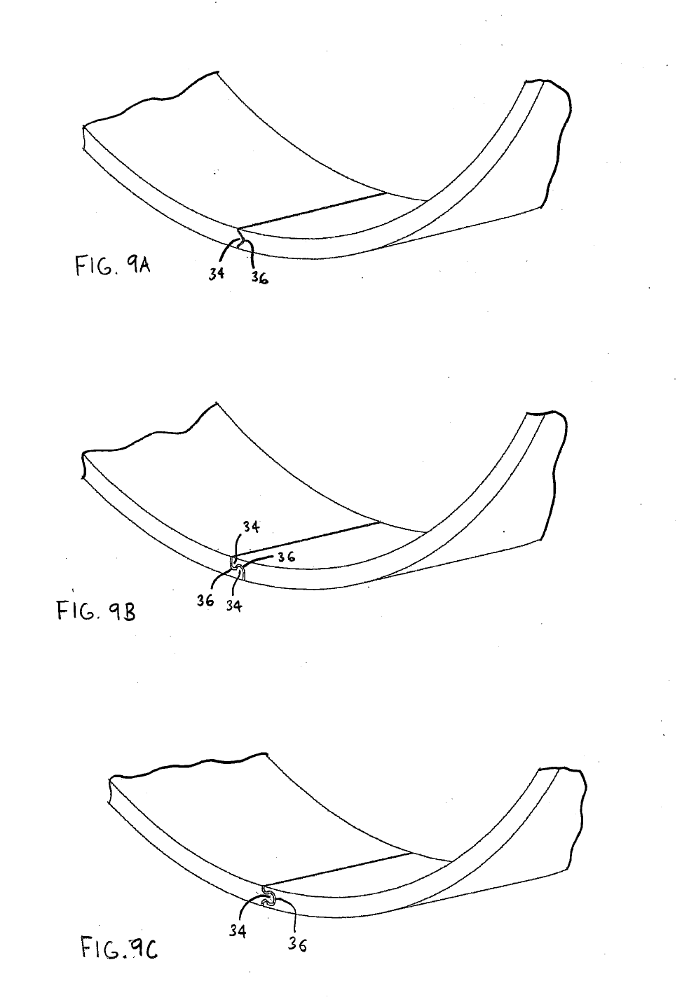

As depicted in FIG. 9, the first radial end 27a of at least one of the first and second tube segments 21A, 21B preferably has a projection 34 and the first radial end 27a of at least the other one of the tube segments 21B, 21A has a recess 36. The recess(es) 36 is/are configured to receive the projection(s) 34 so as to interlock the first and second tube segments 21A, 21B, which is particularly beneficial when installing the bushing 10 in the manner as described below. The projection 34 may extend from only one of the first radial ends 27a and be formed with generally wedge-shaped radial cross-sections (FIG. 9A), generally ball-shaped radial cross-sections (FIG. 9C) or in any other appropriate manner, with a mating recess 36 formed in a complementary fashion in the other first radial end 27a. Alternatively, the first radial ends 27a of both the first and second tube segments 21A, 21B may be formed with both a projection 34 and a recess 36, such as for example, an interlocking “S”-shaped interface as depicted in FIG. 7B. As a further alternative, the two mating ends 27a, 27b of the first and second tube segments 21A, 21B may be formed to generally abut without interlocking.

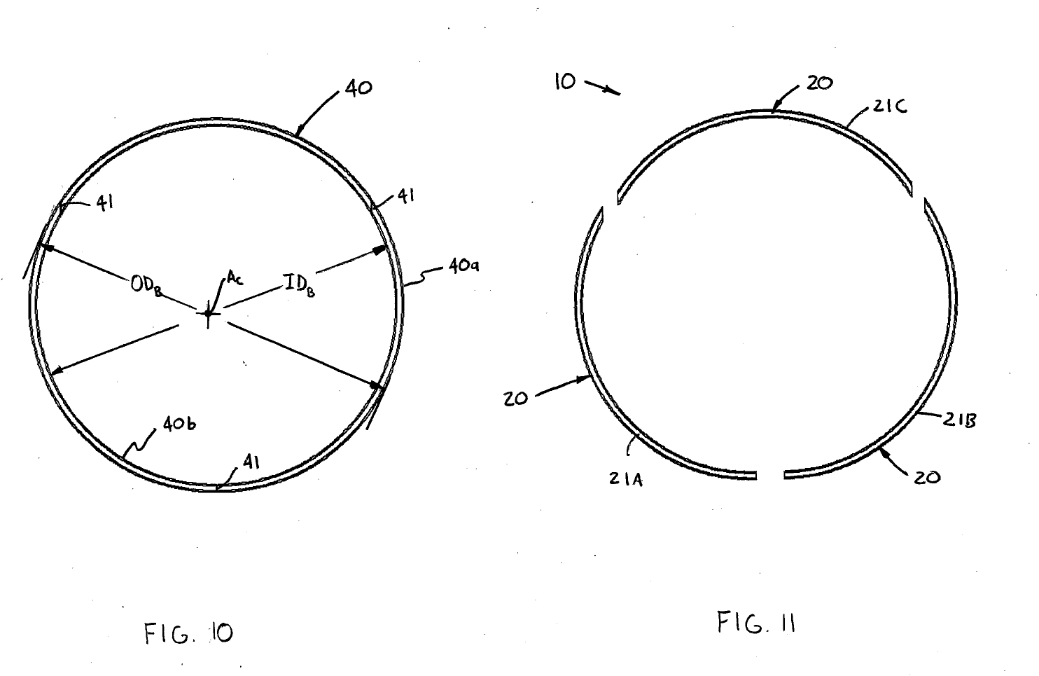

Referring to FIGS. 10 and 11, the bushing 10 is preferably formed by first fabricating a solid, generally tubular body or bushing 40 of a metallic material, as shown in FIG. 10 with markings 41 to indicate intended separation zones/planes. The tubular body/bushing 40 has an outer circumferential surface 40a sized to fit within the housing annular groove 18 and an inner circumferential surface 40b sized to receive at least a portion of the shaft 12. More specifically, the solid bushing 40 is formed having an inside diameter ID_{B} with a selected value approximately or generally equal to the measured value of the shaft outside diameter OD_{S} and an outside diameter OD_{B} with a selected value generally/approximately equal to the measured value of the inside diameter ID_{G} of the housing groove 18 (described in further detail below). Then, the solid bushing 40 is separated into the plurality of tube segments 20 by any appropriate means, such for example, cutting with a wire EDM (“electrical discharge machine”), a saw, a torch, a water jet or a laser device, so as to form the tube segments 20, as indicated in FIG. 11.

The separating or cutting process is conducted so as to form the first and second ends 27a, 27b of each tube segment 20 with the radial end surfaces 30, 32, projection(s) 34 and recess(es) 36 as described above.

It must be noted that the solid bushing 40 may either be fabricated to fit an existing housing groove 18 or an existing (i.e., “prefabricated”) solid bushing 40 may be selected, and the groove 18 formed (e.g., machined) in the housing 14 to accommodate the tube segments 20 cut from the selected solid bushing 40. Specifically, the size of a section (e.g., the groove 18) of the housing inner circumferential surface 16 and the size of the shaft outer circumferential surface 12a may first be determined, for example by measuring the inside diameter ID_{G} of the housing groove 18 and the outside diameter OD_{S} of the shaft outer surface 12a. Then, the solid bushing 40 may be fabricated as discussed above to fit within the groove 18 and receive at least a section of the shaft 12.

Alternatively, the solid bushing 40 may be selected from existing prefabricated or manufactured stock, such as for example, a bushing intended for a different application, having an inside diameter ID_{B} appropriately sized to receive the shaft 12. Then, the groove 18 is formed within the housing inner circumferential surface 16 by a machining process, such as boring, to the required dimensions to accommodate the tube segments 20 cut from the solid body/bushing 40.

Referring to FIGS. 3, 4, 5 and 18, the bushing 10 in combination with the housing 14 forms a support assembly 15 for a movable cylindrical body or shaft 12 (FIG. 19). Although depicted as a generally circular cylinder with an axial length that is not substantially greater than axial length/width of the bushing 10, the housing 14 may be any appropriate body or assembly for at least partially containing the cylindrical body 12, such as for example, a pump body, a cylinder of a piston device, a pillow block for a bearing, etc, and may have any appropriate size or shape. As discussed above, the housing 14 has an inner surface 16 extending circumferentially about the axis A_{c}, which defines a bore 17 for receiving at least a portion of the cylindrical body or shaft 12, and opposing axial ends 14a, 14b. The annular groove or gland 18 extends radially outwardly from a remainder of the housing inner surface 16 and circumferentially about the axis A_{C}, and has opposing axial ends 18a, 18b.

Preferably, the groove 18 is spaced from the two axial ends 14a, 14b of the housing 14 by a first axial distance d₁ between the housing first end 14a and the groove first axial end 18a and a second axial distance d₂ between the housing second end 14b and the groove second end 18b, each distance d₁, d₂ being greater than zero such that the groove 18 is not “open ended”. The spacing distances d₁, d₂ may be generally equal, such that the groove 18 is generally centrally located within the housing 14, or may be substantially different, such that the groove 18 is located more proximal to one of the two axial ends 14a or 14b than to the other end 14a, 14b. Further, the groove 18 may be formed in the housing 14 by any appropriate means, such as for example, machining the groove 18 into a finished housing 14, casting or forging the groove 18 during casting/forging of the housing 14, etc.

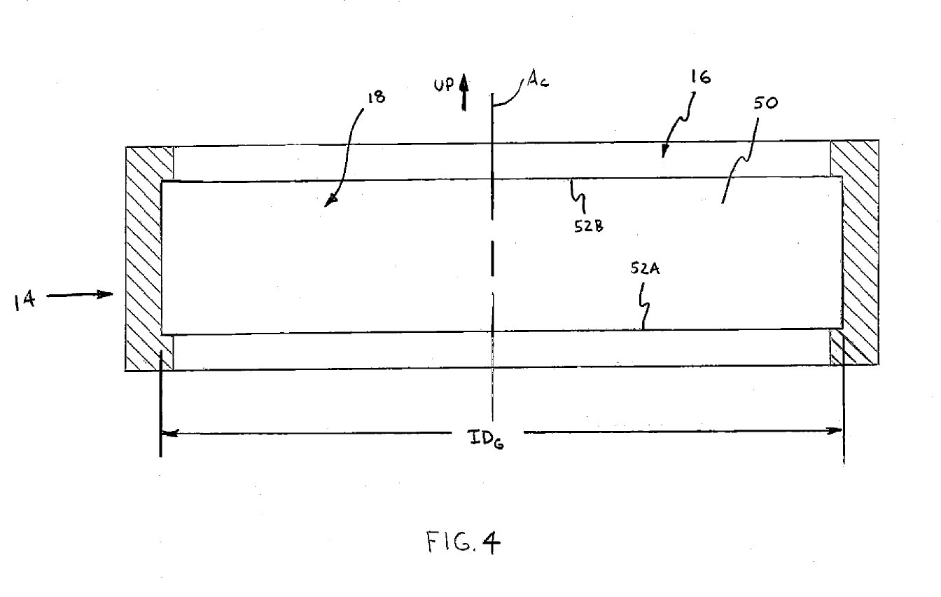

As best shown in FIG. 4, the groove 18 includes an inner circumferential surface 50, which is spaced radially outwardly from the housing inner surface 16 and has an inside diameter ID_{G}, and two facing shoulder surfaces 52A, 52B. The shoulder surfaces 52A, 52B are spaced axially apart and extend generally radially between the groove inner surface 50 and the housing inner surface 16. As such, the housing groove/gland 18 has an axial width W_{AG} defined as the axial or perpendicular distance between the shoulder surfaces 52A, 52A (i.e., and thus between the two axial ends 18a, 18b) and a radial depth d_{R} defined as the radial distance between the housing inner surface 16 and the groove inner surface 50. In one presently preferred application, the housing 14 is oriented with the central axis A_{c} extending generally vertically, such that the two shoulder surfaces 52A, 52B extend generally horizontally, one shoulder surface 52A facing generally upwardly and providing a support surface, as discussed below.

Further, the housing groove 18 is sized to receive the bushing tube segments 20 with a slight axial clearance and with each of the segments 20 projecting radially inwardly with respect to the housing inner surface 16 and into the bore 17. That is, the axial width W_{AS} of each tube segment 20 is lesser than the groove axial width W_{AG}, such that all of the tube segments 20 fit within the groove 18 with clearance, as best shown in FIG. 5. Also, the radial thickness t_{R} of each tube segment 20 is greater than the groove radial depth d_{R} such that the bearing surface 23 is spaced radially inwardly from the housing surface 16. Thus, the cylindrical body or shaft 12 only contacts the bearing surface 23 and not the housing inner surface 16. Furthermore, the inside diameter ID_{G} of the housing groove 18 is sized slightly larger than the outside diameter OD_{B} of the assembled bushing body 11 to receive all the bushing segments 20 with minimal radial clearance.

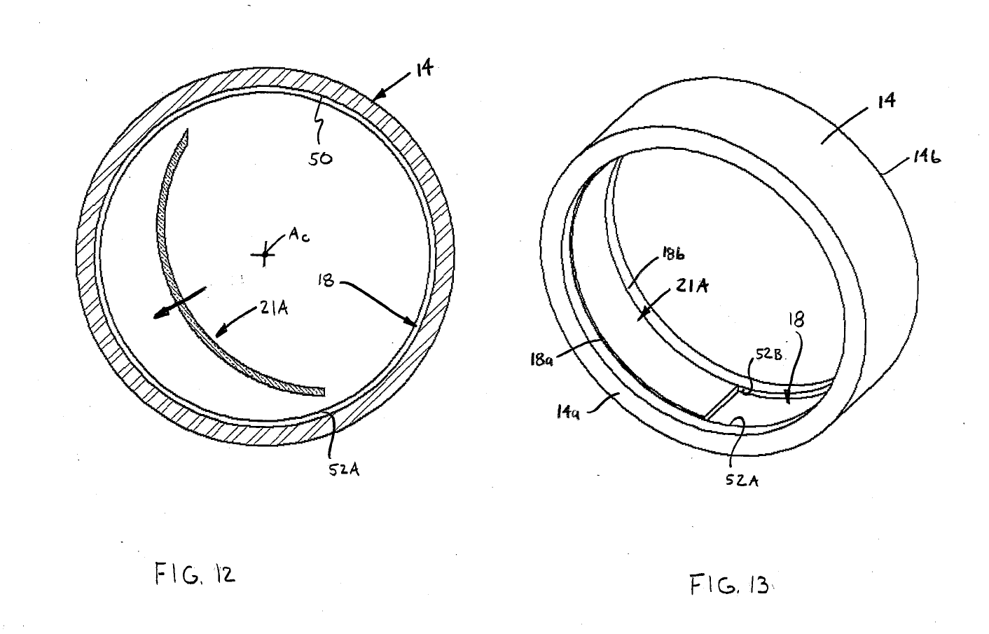

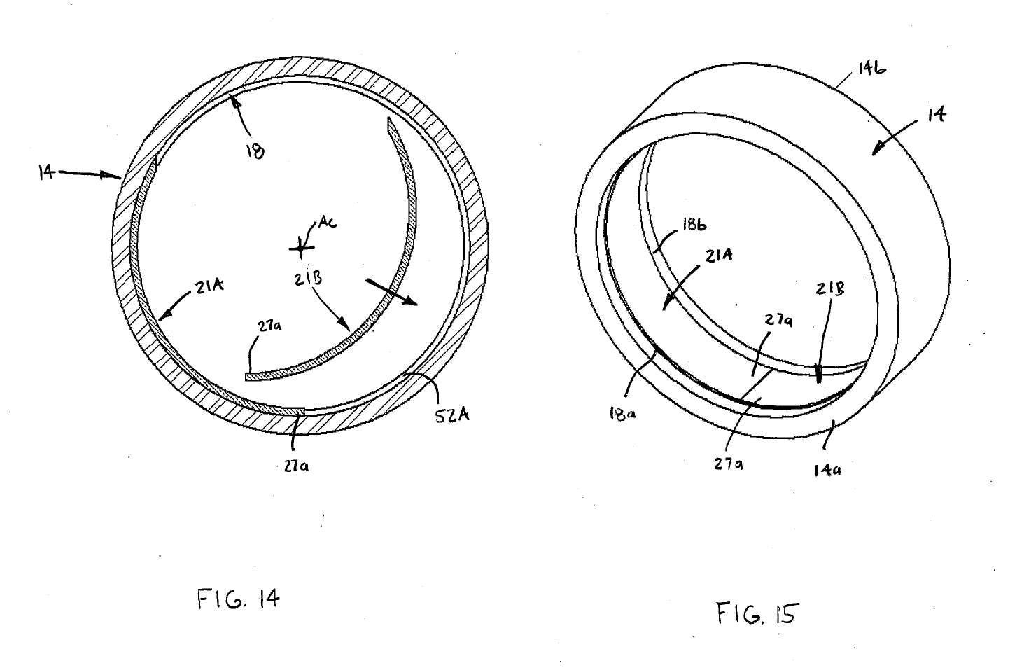

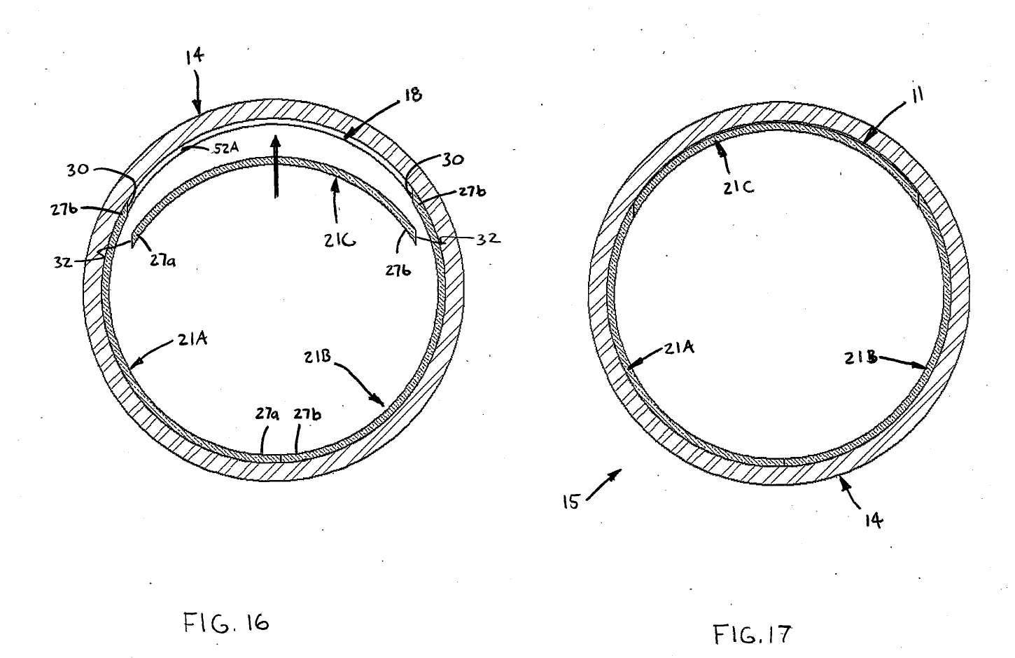

Referring now to FIGS. 12-19, in the preferred application described above with a substantially vertically-extending central axis A_{c}, the plurality of bushing tube segments 20 are installed within the groove 18 in the following manner The first tube segment 21A is first inserted into the groove 18 and positioned such that one axial end 28 of the first segment 21A is disposed on the groove support surface 52A, and the segment outer surface 24 contacts the groove inner surface 50, as shown in FIGS. 12 and 13. Next, the second tube segment 21B is inserted into the groove 18 such that one axial end 28 is disposed on the groove support surface 54, the segment outer surface 24 is disposed on the groove inner surface 50, and the first radial end 27a of the second segment 21B is adjacent to, and preferably abutting, the first radial end 27a of the first segment 21A, as depicted in FIGS. 14 and 15. If present, the projection(s) and recess(es) of the first and second tubular segments 21A, 21B are engaged to interlock. Then, as shown in FIGS. 16 and 17, the third tube segment 21C is inserted into the housing groove 18 such that one axial end 28 of the third segment 21C is disposed on the groove support surface 52 and each third segment angled end surface 32 is juxtaposed with a separate one of the angled end surfaces 30 of the first and second segments 21A, 21B.

More specifically, the third tube segment 21C is positioned generally between the first and second segments 21A, 21B and is then displaced generally radially outwardly, as indicated in FIG. 16. The two outwardly angled end surfaces 32 of the third segment 21C slide against the two inwardly-angled end surfaces 30 of the first and second segments 21A, 21B until the mating surfaces are juxtaposed and the third segment outer surface 24 is disposed against the groove inner surface 50, as shown in FIGS. 17 and 18. Thereafter, the cylindrical body 12 (shaft, piston, etc.) is displaced generally vertically along the axis A_{C} to first enter one end of the housing bore 17 and then extend through the bushing bore 25, such that the cylindrical body 12 prevents radially-inward displacement of the tube segments 20 and thereby retains the segments 20 within the housing groove 18 and forms as shaft assembly 13, as shown in FIG. 19.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A method of fabricating a bushing for supporting a shaft within a housing, the housing having an inner circumferential surface and the shaft having an outer circumferential surface, the method comprising the steps of:
determining a size of a section of the housing inner circumferential surface and a size of the shaft outer circumferential surface;
fabricating a generally tubular body having an outer circumferential surface sized to fit within the housing inner surface section and an inner circumferential surface sized to receive at least a portion of the shaft; and
separating the tubular body into a plurality of generally arcuate tube segments.

2. The method as recited in claim 1 wherein:
the shaft has an outside diameter with a value;
the housing inner surface section has an inside diameter with a value; and
the step of fabricating the generally tubular body includes forming the body with an inside diameter having a selected value at least generally equal to the value of the shaft outside diameter and an outside diameter having a selected value at least generally equal to the value of the groove inside diameter.

3. The method as recited in claim 2 wherein the step of determining the size of a section of the housing inner circumferential surface includes one of:
measuring an inside diameter of the housing inner circumferential surface section: and
forming an annular groove in the housing extending radially outwardly from a remainder of the inner circumferential surface and having an inside diameter with the value.

4. The method as recited in claim 2 wherein the housing has a generally annular groove extending radially outwardly from a remainder of the housing inner circumferential surface and the step of determining a size of a section of the housing inner circumferential surface includes measuring the inside diameter of the annular groove.

5. The method as recited in claim 1 wherein the step of separating the tubular body includes cutting the tubular body.

6. The method as recited in claim 1 wherein the step of separating the tubular body includes forming each one of the plurality of segments with two opposing radial ends and two opposing axial ends such that each segment radial end is disposeable generally adjacent to one of the radial ends of one of the other tube segments and each segment axial end is generally axially alignable with one of the two axial ends of each one of the other tube segments.

7. The method as recited in claim 6 wherein the plurality of segments includes a first segment, a second segment and a third segment, each one of the first and second segments having a first end disposeable adjacent to a first end of the other one of the first and second segments and a an opposing, second radial end with an angled end surface facing generally toward the central axis, the third segment having an angled end surface on each of the two radial ends, each one of the two angled end surfaces of the third segment facing generally away from the central axis and being generally juxtaposable with a separate one of the angled end surfaces of the first and second tube segments.

8. The method as recited in claim 1 wherein the step of fabricating the generally tubular body includes forming the body of a metallic material.

9. A method of supporting a shaft within a housing, the housing having an inner circumferential surface, the method comprising the steps of:
forming an annular groove in the inner circumferential surface of the housing;
providing a plurality of generally arcuate tube segments; and
installing the tube segments within the annular groove such that the tube segments are aligned circumferentially about the central axis so as to form a generally tubular body configured to slidably support the cylindrical body.

10. The method as recited in claim 9 wherein the step of providing a plurality of tube segments includes the substeps of:
fabricating a generally tubular body having an outer surface sized to fit within the housing inner surface section and an inner surface sized to receive a portion of the shaft;
and separating the tubular body into a plurality of generally arcuate tube segments.

11. The method as recited in claim 10 wherein:
the shaft has an outside diameter with a value;
the step of forming the groove includes forming the groove with an inside diameter having a value; and
the substep of fabricating the generally tubular body includes forming the body with an inside diameter having a selected value at least generally equal to the value of the shaft outside diameter and an outside diameter having a selected value at least generally equal to the value of the groove inside diameter.

12. The method as recited in claim 9 wherein the step of installing the plurality of tube segments includes arranging the segments such that each segment radial end is located generally adjacent to one of the radial ends of one of the other tube segments and each segment axial end is generally axially aligned with one of the two axial ends of each one of the other tube segments.

13. The method as recited in claim 12 wherein the plurality of tube segments includes a first segment, a second segment and a third segment, each one of the first and second segments having a first end adjacent to a first end of the other one of the first and second segments and a an opposing, second radial end with an angled end surface facing generally toward the central axis, the third segment having an angled end surface on each of the two radial ends, each one of the two angled end surfaces of the third segment facing generally away from the central axis and being generally juxtaposed with a separate one of the angled end surfaces of the first and second tube segments.

14. The method as recited in claim 13 wherein:
the housing is oriented such that the central axis extends generally vertically;
the annular groove has an inner circumferential surface spaced radially outwardly from the housing inner surface and two facing shoulder surfaces spaced axially apart and extending radially and generally horizontally between the groove inner surface and the housing inner surface, one of the two shoulder surfaces facing generally upwardly and providing a support surface; and
the step of installing the tube segments includes inserting the first tube segment into the groove such that one axial end of the first segment is disposed on the groove support surface, inserting the second tube segment into the groove such that one axial end is disposed on the groove support surface and the second segment first radial end is adjacent to the first segment first radial end, and inserting the third tube segment into the groove such that one axial end of the third segment end is disposed on the groove support surface and each third segment angled end surface is juxtaposed with a separate one of the angled end surfaces of the first and second segments.

15. The method as recited in claim 9 wherein the housing has opposing first and second axial ends and the step of forming the housing groove includes forming the groove with opposing first and second axial ends, the groove first end being spaced from the housing first axial end by a first axial distance and the groove second axial end being spaced from the housing second axial by a second axial distance, each of the first and second distances being greater than zero.

16. The method as recited in claim 9 wherein the housing has a central axis and the method further comprises the step of displacing the shaft generally along the axis until the shaft is disposed within the housing after the tube segments have been installed within the housing groove so as to retain the tube segments within the groove.
